(19) United States
(12) Patent Application Publication
(10) Pub. No.: US 2013/0031460 A1
(43) Pub. Date: Jan. 31, 2013

(54) USING A COMMON INPUT/OUTPUT FORMAT TO GENERATE A PAGE OF AN ELECTRONIC DOCUMENT

(71) Applicant: Kurt N. Nordback, Boulder, CO (US)

(72) Inventor: Kurt N. Nordback, Boulder, CO (US)

(73) Assignee: KONICA MINOLTA LABORATORY U.S.A., INC., San Mateo, CA (US)

(21) Appl. No.: 13/194,838

(22) Filed: Jul. 29, 2011

(51) Int. Cl. G06F 17/00

(52) U.S. Cl. 715/234; 715/243

(57) ABSTRACT

A method for generating a page of an electronic document (ED), including: obtaining a common input/output (I/O) format of the ED, where the common I/O format comprises the properties, the objects, and fields corresponding to the objects; populating, during a first layout by a layout engine and based on the properties, the fields in the common I/O format of the ED with coordinates; and generating, from the common I/O format of the ED, the page by placing the objects on the page according to the coordinates.

### BACKGROUND

An electronic document (ED) may be characterized/described in both a markup language and a page description language. A markup language provides a high level, conceptual description of the ED. For example, a markup language may specify the margins, spacing, and fonts, of the ED and identify the objects (e.g., text characters, symbols, graphical objects including images, photographs, clipart, etc.) of the ED. The content implicitly determines the positioning of objects on the page. However, the markup language does not explicitly specify the position (i.e., coordinates) of the objects. Further, the markup language does not necessarily specify the page breaks of the ED. Example markup languages include, but are not limited to, hyper text markup language (HTML), Office Open Extensible markup language (OOXML), and TeX.

A page description language (PDL) provides explicit, or very simply derived, positioning details (i.e., coordinates) for one or more objects (e.g., text characters, symbols, graphical objects including images, photographs, clipart, etc.) in the ED. Further, a PDL may identify the page breaks of the ED. Example PDLs include, but are not limited to, device independent file format (DVI), portable document format (PDF), PostScript, and XPS (XML Paper Specification).

In general, it is the responsibility of a layout engine on a Page Rendering Device (PRD) to generate a PDL description of the ED from the markup language description of the ED. In other words, it is the responsibility of the layout engine to calculate the coordinates of the objects in the ED based on the margins, fonts, spacing, etc. Even though maintaining/storing the two descriptions of the same ED may be a burden on memory, layout engines continue to input and output different descriptions of the same ED.

### SUMMARY OF INVENTION

In general, in one aspect, the invention relates to a method for generating a page of an electronic document (ED). The method comprises: obtaining a common input/output (I/O) format of the ED, where the common I/O format comprises the properties, the objects, and fields corresponding to the objects; populating, during a first layout by a layout engine and based on the properties, the fields in the common I/O format of the ED with coordinates; and generating, from the common I/O format of the ED, the page by placing the objects on the page according to the coordinates.

In general, in one aspect, the invention relates to system for generating a page of an electronic document (ED). The system comprises a hardware processor and a layout engine executing on the hardware processor, where the layout engine is configured to: obtain a common input/output (I/O) format of the ED, wherein the common I/O format comprises objects, properties, and fields corresponding to the objects; populate, during a first layout and based on the properties, the fields in the common I/O format of the ED with coordinates; and generate, from the common I/O format of the ED, the page by placing the objects on the page according to the coordinates.

In general, in one aspect, the invention relates to a non-transitory computer readable storage medium storing computer readable program code embodied therein for performing a method for generating a page of an electronic document (ED). The method comprises: receiving the ED comprising objects and properties; generating a common input/output (I/O) format of the ED, where the common I/O format comprises the properties, the objects, and fields corresponding to the objects; sending the common I/O format of the ED to a layout engine, where the layout engine is configured to populate, during a first layout and based on the properties, the fields in the common I/O format of the ED with coordinates; and generating, from the common I/O format of the ED, the page by placing the objects on the page according to the coordinates.

Other aspects of the invention will be apparent from the following description and the appended claims.

### BRIEF DESCRIPTION OF DRAWINGS

FIGS. 1A and 1B each show block diagrams depicting a system in accordance in with one or more embodiments of the invention.

FIG. 2 shows a flowchart in accordance in with one or more embodiments of the invention.

FIGS. 3A, 3B, and 3C show examples in accordance in with one or more embodiments of the invention.

FIGS. 4 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a system and method for rendering a page of an ED using a common input/output (I/O) format. Specifically, the input to the layout engine and the output from the layout engine have the same common I/O format. More specifically, the common I/O format includes one or more fields associated with the objects (e.g., text characters, symbols, graphical objects, etc.) of the ED. The layout engine populates the fields during one or more layouts of the ED. In other words, the common I/O format has the properties of, and functions as, both a markup language and a page description language.

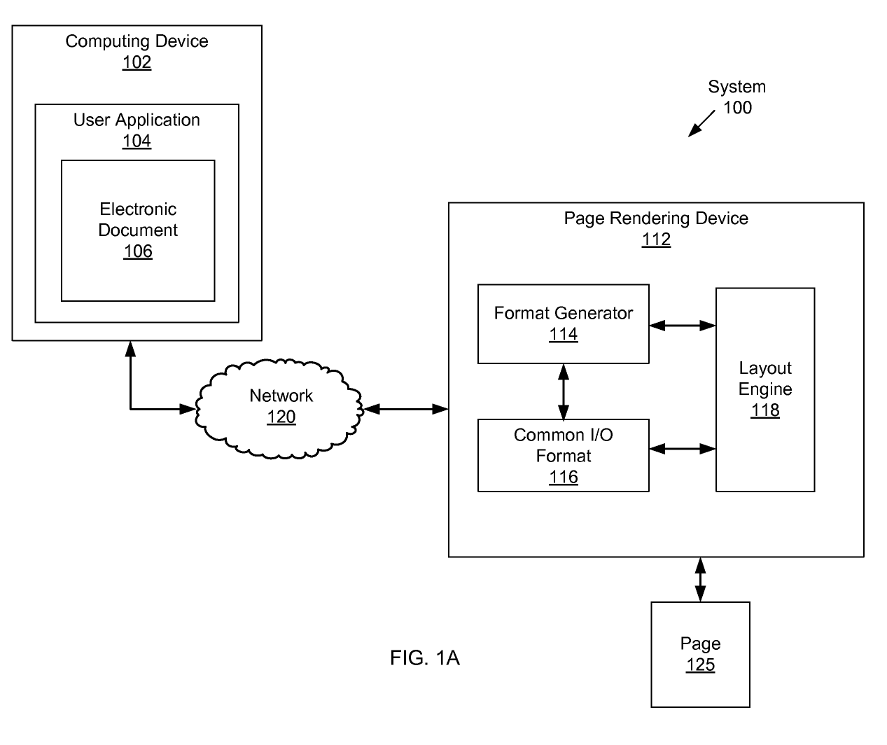

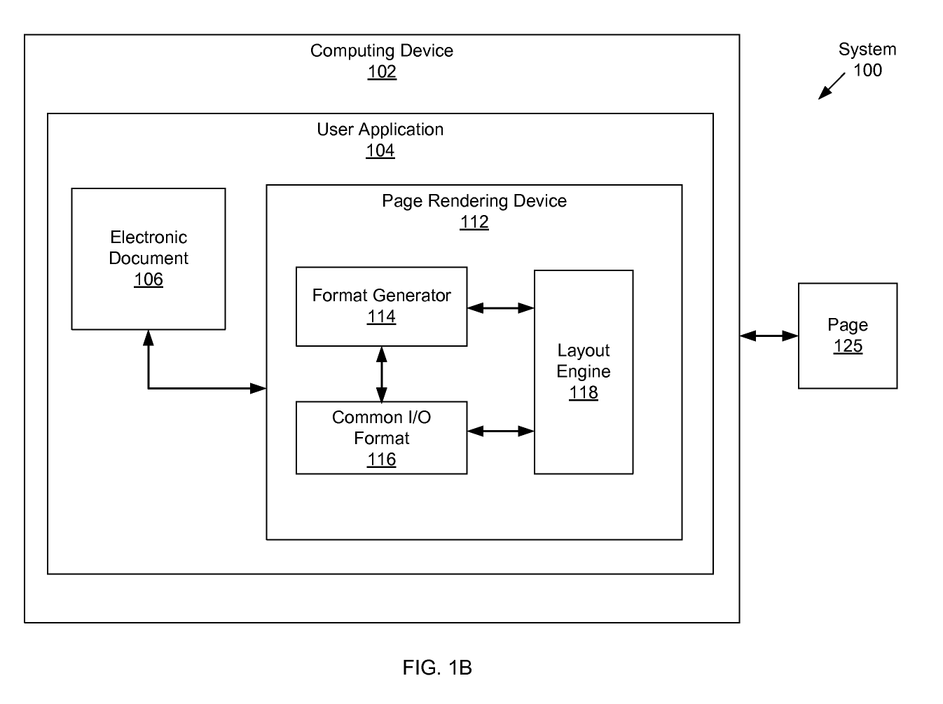

FIG. 1A shows a system (100) in accordance with one or more embodiments of the invention. As shown in FIG. 1A, the system (100) has multiple components including a page rendering device (PRD) (112) and a computing device (102). The PRD (112) may be a printer, an electronic reader, a web browser, a word processor, etc. The computing device (102) may be a personal computer (PC), a desktop computer, a mainframe, a server, a telephone, a kiosk, a cable box, a personal digital assistant (PDA), an electronic reader, a mobile phone, a smart phone, etc. There may be a direct connection (e.g., universal serial bus (USB) connection) between the computing device (102) and the PRD (112). Alternatively, the computing device (102) and the PRD (112) may be connected using a network (120) having wired and/or wireless segments.

In one or more embodiments of the invention, the PRD (112) is located on the computing device (102). In such embodiments, the PRD (112) may correspond to any combination of hardware and software on the computing device (102) for rendering an ED.

In one or more embodiments of the invention, the computing device (102) executes the user application (104). The user application (104) is a software application operated by a user and configured to obtain, input, generate, display, and/or print an ED (e.g., Electronic Document (106)) having any number of pages. Accordingly, the user application (104) may be a word-processing application, a spreadsheet application, a desktop publishing application, a graphics application, a photograph printing application, an Internet browser, etc. The user application (104) may generate new EDs and/or obtain previously saved EDs.

In one or more embodiments of the invention, the ED (106) includes one or more objects. An object is any element of the ED (106) that is visible to a user. Accordingly, example objects include, but are not limited to, text characters, symbols, and graphical objects (e.g., clipart, photographs, drawings, etc.). The ED (106) may have any number of objects. Further, the ED (106) may also specify/identify one or more properties. The properties define formatting characteristics of the ED (106). For example, properties may include, but are not limited to, font style(s), font size(s), spacing, and margins. In other words, the ED (106) specifies/identifies the objects and properties needed to correctly display or print the ED.

In one or more embodiments of the invention, the ED (106) is represented/defined using a document markup language (e.g., ODF, OOXML, etc.). Accordingly, the objects (e.g., text characters, symbols, graphical objects) and the properties (e.g., spacing, fonts, font sizes, etc.) of the ED (106) may be recorded as attributes within the tags of the document markup language. Moreover, these attributes may be used to correctly render the ED (106) for display or printing.

In one or more embodiments of the invention, the PRD (112) includes a format generator (114). The format generator (114) is configured to generate the common I/O format (116) of the ED (106). The common I/O format (116) of the ED (106) is both the input format to layout engines (e.g., layout engine (118) (described below)) and the output format from the layout engines. The common I/O format (116) of the ED (106) created by the format generator (114) specifies/identifies the objects and the properties, both described above, of the ED (106). The format generator (114) may specify the properties and/or the objects of the common I/O format (116) using tags.

In one or more embodiments of the invention, the common I/O format (116) of the ED (106) created by the format generator (114) includes one or more fields for each object. During the layout process, the field(s) are populated with the position (e.g., x-y coordinates) of the corresponding object on the page (125) of the ED (106). In one or more embodiments of the invention, fields are placed immediately following their respective objects within the common I/O format (116). In one or more embodiments of the invention, fields are placed immediately before their respective objects within the common I/O format (116). In one or more embodiments of the invention, fields are placed immediately before and immediately after their respective objects within the common I/O format (116). An object and its field(s) may be separated from another object and its field(s) by a character separator (e.g., “|”) within the common I/O format (116). In one or more embodiments of the invention, one or more fields are located on top of at least one property specified in the common I/O format (116). In such embodiments of the invention, populating the one or more fields includes overwriting the at least one specified property with the coordinates of the corresponding object.

In one or more embodiments of the invention, fields are placed in one or more tables. In other words, the common I/O format (116) includes one or more tables (e.g., at the start, middle, and/or end of the common I/O format), and the entries in each table are the fields corresponding to the objects. The order of the fields in the table(s) may match the order in which the objects are specified/identified within the common I/O format (116). In other words, the first entry (field) in the table corresponds to the first object specified in the common I/O format (116). Similarly, the second entry (field) in the table corresponds to the second object specified in the common I/O format (116). Unlike objects, fields/tables and the coordinates that populate the fields/tables are generally not visible when the ED (106) is displayed and/or printed.

In one or more embodiments of the invention, the common I/O format (116) of the ED (106) generated by the format generator (114) includes a fill-in box. The fill-in box is similar to the field(s) in that the fill-in box will be populated with a value by a layout engine. However, unlike the field(s), the content of the fill-in box is visible to the user (i.e., the content of the fill-in box appears on the rendered page (125)). In one or more embodiments of the invention, the fill-in box corresponds to a page number, a filename of the ED (106), a date/time the rendered page (125) is created, a docket number, etc. The content of the fill-in box is specified/identified within the common I/O format. Further, the fill-in box may have a corresponding field for recording the position (i.e., coordinates) of the fill-in box on the page (125).

In one or more embodiments of the invention, the PRD (112) includes a layout engine (118). The layout engine (118) is configured to layout a page (125) of the ED (106) from the common I/O format. The layout engine (118) calculates the positions (i.e., coordinates) of the objects and/or fill-in boxes specified/identified in the common I/O format (116) and populates the corresponding fields with the coordinates. The layout engine (118) may also populate the content of the fill-in box(es) in the common I/O format (116). Those skilled in the art, having the benefit of this detailed description, will appreciate that the input to the layout engine (118) and the output from the layout engine (118) are both in the common I/O format. However, in general, the fields in the common I/O format accepted by the layout engine (118) are unpopulated, while the fields in the common I/O format outputted by the layout engine (118) are populated. The page (125) may be printed/displayed from the common I/O format outputted by the layout engine (118).

In one or more embodiments of the invention, depending on the location of the fields, populating one or more of the fields includes overwriting one or more properties specified in the common I/O format. In other words, a property specified in the common I/O format (116) of the ED (106) may be overwritten with the coordinates of one or more objects.

In one or more embodiments of the invention, the layout engine (118) is further configured to detect, during an iteration of layout after populating the fields with coordinates, one or more conflicts between (i.e., overlapping of) one or more objects. As a result of a conflict, the layout engine (118) may resolve each conflict by repopulating or updating one or more corresponding fields with different coordinates that correspond to a new position of one or more objects on the page (125). In other words, the layout engine (118) may execute multiple layouts in order to correctly populate every field of the common I/O format. During each subsequent layout, the layout engine (118) may update one or more already populated fields.

FIG. 1B shows an alternative configuration of a system (100) in accordance with one or more embodiments of the invention. FIG. 1B shows the same components as FIG. 1A (except for the network). However, in FIG. 1B, the PRD (112) and its components (i.e., format generator (114), common I/O format (116), and layout engine (118)) are part of the user application (104). Otherwise, the components of the system (100) shown in FIG. 1B function substantially the same as the functions described above with respect to the components in the system (100) of FIG. 1A.

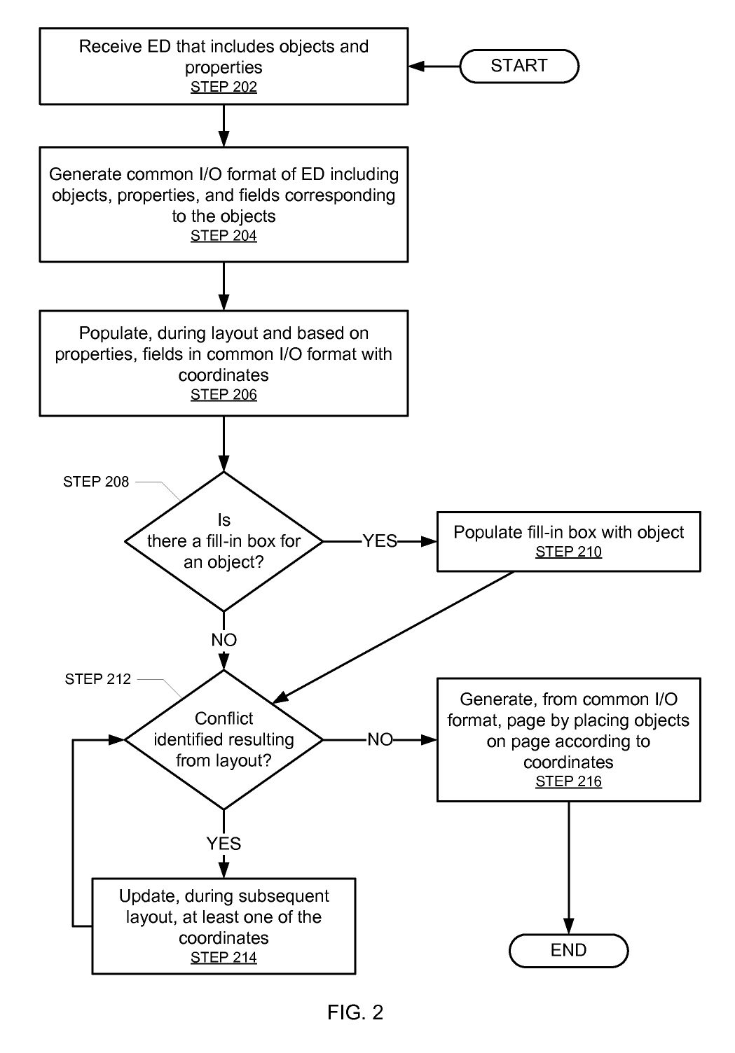

FIG. 2 shows a flowchart for generating a page of an ED using a common I/O format in accordance with one or more embodiments of the invention. The process depicted in FIG. 2 may be implemented using one or more of the components in the system (100) (e.g., layout engine (118)), described above in reference to FIGS. 1A and 1B. One or more steps shown in FIG. 2 may be omitted, repeated, and/or performed in a different order among different embodiments of the invention. Accordingly, embodiments of the invention should not be considered limited to the specific number and arrangement of steps shown in FIG. 2.

Initially, an ED is obtained (STEP 202). In one or more embodiments of the invention, the ED includes one or more properties (e.g., font size(s), font type(s), margin(s), spacing) and one or more objects (e.g., a text character, a symbol, a graphical object). In one or more embodiments of the invention, the ED is represented/defined using a document markup language (e.g., ODF, OOXML, etc.). Accordingly, the objects (e.g., text characters, symbols, graphical objects) and the properties (e.g., spacing, fonts, font sizes, etc.) of the ED (106) may be recorded as attributes within the tags of the document markup language.

In STEP 204, a common I/O format of the ED is generated. In one or more embodiments of the invention, the common I/O format of the ED includes the objects and properties of the ED and multiple fields corresponding to the objects. The properties may be specified/identified in the common I/O format using tags. The fields may be located anywhere within the common I/O format. For example, fields may be placed immediately following their respective objects within the common I/O format of the ED. As another example, fields may be placed immediately before their respective objects within the common I/O format of the ED. As yet another example, fields may be placed immediately before and immediately after their respective objects within the common I/O format of the ED. An object and its field(s) may be separated from another object and its field(s) by a character separator (e.g., “|”) within the common I/O format. In one or more embodiments of the invention, STEP 204 may be omitted because the ED is already in the common I/O format. In other words, the ED is delivered in the common I/O format from a user application.

In one or more embodiments of the invention, fields are placed in one or more tables. In other words, the common I/O format includes one or more tables (e.g., at the start, middle, and/or end of the common I/O format of the ED), and the entries in each table are the fields corresponding to the objects. The order of the fields in the table(s) may match the order in which the objects are specified/identified within the common I/O format. In other words, the first entry (field) in the table corresponds to the first object specified in the common I/O format. Similarly, the second entry (field) in the table corresponds to the second object specified in the common I/O format. Unlike objects, fields and tables are generally not visible when the ED is displayed and/or printed.

In one or more embodiments of the invention, the common I/O format of the ED includes a fill-in box. A fill-in box may be a virtual placeholder specified by the ED that is used when an object cannot be determined until the layout engine executes a layout of a page. For example, a fill-in box may be used for a page number in a common I/O format of an ED. As another example, a fill-in box may be used in a common I/O format of an ED for a file name of the ED. Those skilled in the art will appreciate that a fill-in box may be used for a number of other objects.

In STEP 206, the fields in the common I/O format of the ED are populated with coordinates. In one or more embodiments of the invention, the fields are populated with coordinates during a layout by a layout engine and are based on the properties (e.g., margins, font style(s), font size(s)) of the ED. The coordinates specify a location on a page of the ED where the object corresponding to the field should be placed. Each coordinate may describe a location on the page in terms of, for example, an ordered pair (e.g., x and y coordinates relative to some point of origin), a section number of a page divided into sections, and a space number on a page.

In one or more embodiments of the invention, one or more fields of the common I/O format are placed on top of at least one property in the common I/O format of the ED. Accordingly, populating the one or more fields includes overwriting the at least one property with coordinates.

In STEP 208, a determination is made as to whether the common I/O format of the ED includes a fill-in box for an object. When it is determined that there is a fill-in box for an object, the process proceeds to STEP 210. When it is determined that there are no fill-in boxes for an object, the process proceeds to STEP 212.

In STEP 210, the fill-in box is populated with the object. In one or more embodiments of the invention, the layout engine determines (i.e., calculates) the particular object needed to populate the fill-in box. The layout engine may determine the particular object used to populate the fill-in box based on one or more factors, including but not limited to a position of the fill-in box on the ED, a tag associated with the fill-in box, and number of pages of the ED that are already laid out. The field associated with the fill-in box may also be populated with coordinates to specify where on the page the content of the fill-in box is to be placed.

In STEP 212, a determination is made as to whether a conflict resulting from a layout exists. In one or more embodiments of the invention, a conflict is where two or more objects overlap on a page of the ED or any situation where multiple layouts need to be executed by the layout engine. When it is determined that a conflict is identified from a layout, the process proceeds to STEP 214. When it is determined that no conflicts are identified from a layout, the process proceeds to STEP 216.

In STEP 214, at least one field in the common I/O format is updated with new coordinates. The field(s) may be updated during a subsequent layout performed by the layout engine. Once the at least one field is updated, the process reverts to STEP 212.

In STEP 216, a page is generated from the common I/O format by placing the objects on the page according to the coordinates. The page may be displayed and/or printed. After STEP 216 is completed, the process ends.

In one or more embodiments of the invention, the common I/O format, having populated fields, is converted to another page description language (e.g., PDF, DVI), which is used to print or display the ED.

Although the steps of FIG. 2 focus on the generation of one page of an ED using the common I/O format of the ED, the steps in FIG. 2 may be repeated any number of time to generate any number of pages of the ED. Those skilled in the art, having the benefit of this detailed description, will appreciate that the input to the layout engine and the output from the layout engine are both in the common I/O format. However, in general, the fields in the common I/O format accepted by the layout engine are unpopulated, while the fields in the common I/O format outputted by the layout engine are populated.

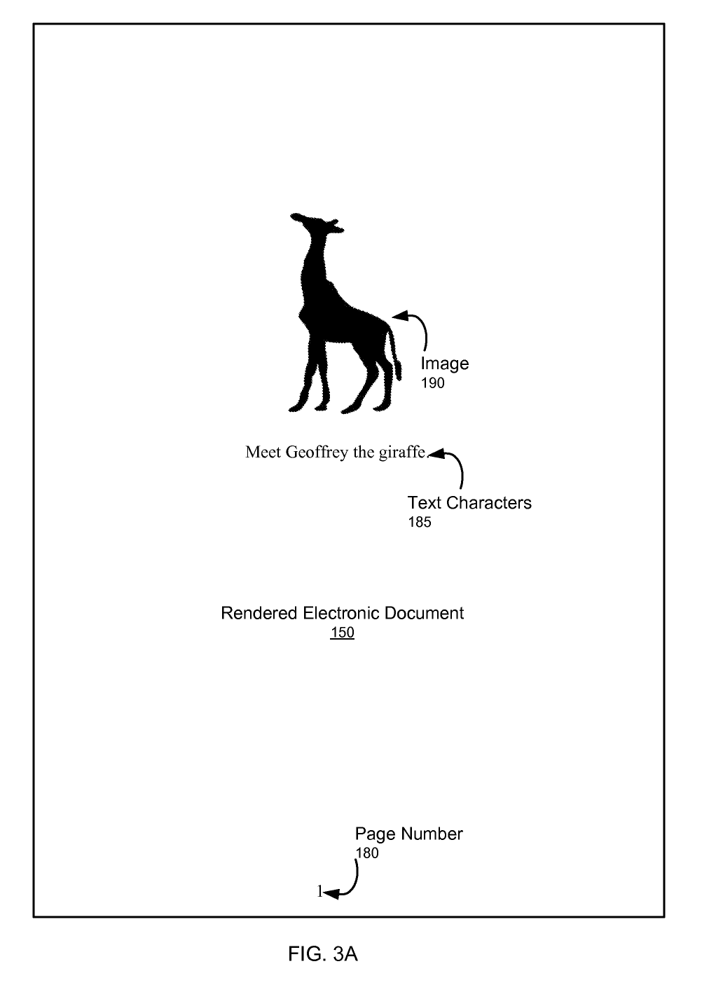

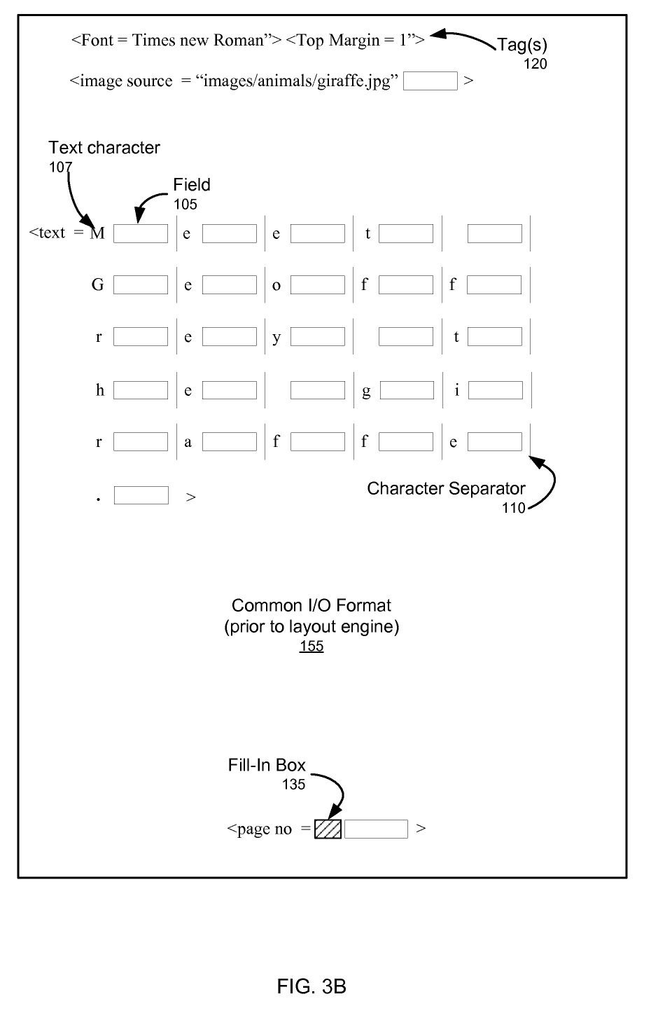

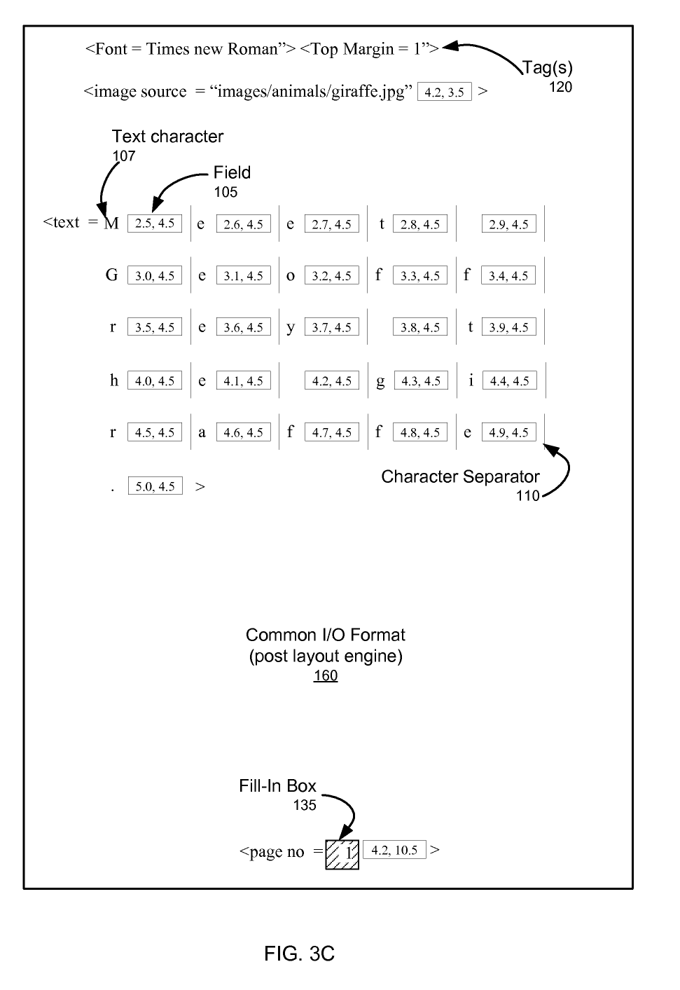

FIGS. 3A, 3B, and 3C show examples in accordance with one or more embodiments of the invention. The examples of FIGS. 3A, 3B, and 3C is related to the process shown in FIG. 2. The ED in these examples includes a graphical object and a text stream.

FIG. 3A shows a rendered page (150) of an ED (e.g., a hardcopy) including a graphical image of a giraffe (i.e., image (190)) located just above the middle of the page, a string of text characters (185) that form the sentence, “Meet Geoffrey the giraffe.” located at the middle of the page, a page number “1” (i.e., page number (180)) located at the bottom center of the page, and some properties (not shown).

FIG. 3B shows a common I/O format (155) of the ED, prior to layout. In other words, the common I/O format (155) is needed to create the rendered page (150). As shown in FIG. 3B, the properties of the ED (e.g., font(s), margin(s)) are specified/identified using tags (120). As also shown in FIG. 3B, each object (e.g., Text Character (107)) is followed by its field (i.e., Field (105)). However, the fields are empty (i.e., not populated) because a layout of the ED has not yet been executed by a layout engine (i.e., the common I/O format (155) of the ED has not yet been inputted to a layout engine). Further, an object and its field may be separated by another object and its field by the character separator (110).

Still referring to FIG. 3B, the common I/O format (155) of the ED includes a fill-in box (135). The fill-in box (135) needs to be populated with the page number of the rendered page (150).

FIG. 3C shows a common I/O format (160) of the ED, post layout. A layout engine has populated the fields with coordinates. For example, the field (105) has been populated with the coordinates “2.5, 4.5” Accordingly, the text character (107) is to be positioned at (2.5,4.5) on the page.

In addition, the layout engine populates the fill-in box (135) with the page number “1.” The layout engine also populates the field associated with the fill-in box with the coordinates “4.2, 10.5.” At this point, the post-layout engine common I/O format (160) of FIG. 3C, with all of the fields populated with coordinates, is prepared for output (e.g., printing, displaying).

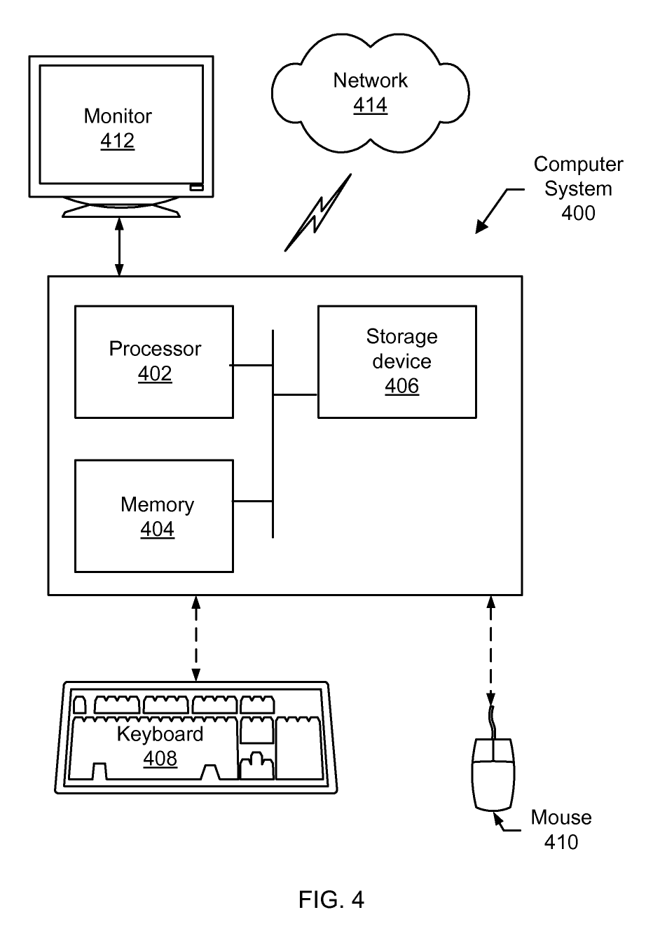

Embodiments of the invention may be implemented on virtually any type of computer regardless of the platform being used. For example, as shown in FIG. 4, a computer system (400) includes one or more hardware processor(s) (402) (such as a central processing unit (CPU), integrated circuit, etc.), associated memory (404) (e.g., random access memory (RAM), cache memory, flash memory, etc.), a storage device (406) (e.g., a hard disk, an optical drive such as a compact disk drive or digital video disk (DVD) drive, a flash memory stick, etc.), and numerous other elements and functionalities typical of today's computers (not shown). The computer system (400) may also include input means, such as a keyboard (408), a mouse (410), or a microphone (not shown). Further, the computer system (400) may include output means, such as a monitor (412) (e.g., a liquid crystal display (LCD), a plasma display, or cathode ray tube (CRT) monitor). The computer system (400) may be connected to a network (414) (e.g., a local area network (LAN), a wide area network (WAN), the Internet, or any other type of network) via a network interface connection (not shown). Those skilled in the art will appreciate that many different types of computer systems exist, and the aforementioned input and output means may take other forms, now known or later developed. Generally speaking, the computer system (400) includes at least the minimal processing, input, and/or output means necessary to practice embodiments of the invention.

Further, in one or more embodiments of the invention, one or more elements of the aforementioned computer system (400) may be located at a remote location and connected to the other elements over a network. Further, embodiments of the invention may be implemented on a distributed system having a plurality of nodes, where each portion of the invention may be located on a different node within the distributed system. In one embodiment of the invention, the node corresponds to a computer system. Alternatively, the node may correspond to a processor with associated physical memory. The node may alternatively correspond to a processor or micro-core of a processor with shared memory and/or resources. Further, software instructions in the form of computer readable program code to perform embodiments of the invention may be stored, temporarily or permanently, on a tangible computer readable storage medium, such as a compact disc (CD), a diskette, a tape, a hard drive, punch cards, memory, or any other tangible computer readable storage device.

Current methods to render an ED lead to distinct but redundant representations of the ED. Specifically, when a layout engine is used as part of larger system (integrated for use with multiple applications and/or other layout engines), a number of redundancies occur each time the ED is rendered. Because there is no standard input format of the ED, the layout engine must fully process the ED every time the ED is sent to the layout engine. For example, the properties of the ED are repeatedly copied every time the ED is processed by a layout engine. As another example, the objects on a page of the ED generally remain the same, but the positioning of those objects may vary each time the ED is processed by a layout engine. Thus, much of the processing with regard to each object is redundant. Such conventional methods are inefficient from a processing standpoint.

Embodiments of the invention generate a common I/O format of the ED so that many of the inefficiencies currently experienced are reduced or eliminated. Specifically, embodiments of the invention reduce the amount of memory required to process an ED. Redundant representations of the ED use more memory, which can become a critical issue in a memory-constrained system.

Further, embodiments of the invention increase performance of the system. For large documents in particular, using two or more representations of the same ED means that a large amount of data must be copied from the input representation to the output representation while performing a layout of each representation. As a result, processing performance of the computer is negatively affected. Processing efficiency is improved using embodiments of the invention, as the common I/O format only requires that the layout engine populate the fields and any fill-in boxes. Consequently, processing efficiency is increased.

Further, embodiments of the invention reduce the number of formats that are maintained for an ED by using the common I/O format. As a result, less software engineering effort is required to maintain the common I/O format as opposed to multiple input formats of the same ED.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for generating a page of an electronic document (ED), comprising:
obtaining a common input/output (I/O) format of the ED, wherein the common I/O format comprises a plurality of properties, a plurality of objects, and a plurality of fields corresponding to the plurality of objects;
populating, during a first layout by a layout engine and based on the plurality of properties, the plurality of fields in the common I/O format of the ED with a plurality of coordinates; and
generating, from the common I/O format of the ED, the page by placing the plurality of objects on the page according to the plurality of coordinates.

2. The method of claim 1, wherein obtaining the common I/O format comprises:
receiving the ED comprising the plurality of objects and the plurality of properties; and
generating the common I/O format of the ED by creating the plurality of fields corresponding to the plurality of objects.

3. The method of claim 1, wherein populating the plurality of fields comprises overwriting at least one of the plurality of properties in the common I/O format of the ED.

4. The method of claim 1, wherein each field of the plurality of fields is adjacent to a corresponding object of the plurality of objects in the common I/O format of the ED.

5. The method of claim 1, wherein the common I/O format of the ED comprises a table having the plurality of fields.

6. The method of claim 1, wherein the common I/O format of the ED further comprises:
a fill-in box for a page number and a field corresponding to the fill-in box,
wherein the layout engine populates the fill-in box with the page number, and
wherein the layout engine populates the field corresponding to the fill-in box with coordinates of the page number.

7. The method of claim 1, wherein the plurality of properties comprises at least one selected from of a group consisting of a font size, a font type, spacing, and a margin.

8. The method of claim 2, wherein the ED is described using at least one language selected from a group consisting of HTML, OOXML, and TeX.

9. The method of claim 1, wherein the plurality of objects comprises at least one selected from a group consisting of a text character, a symbol, and a graphical object.

10. The method of claim 1, further comprising:
identifying a conflict resulting from the first layout; and
updating, during a second layout by the layout engine, at least one of the plurality of coordinates.

11. The method of claim 1, wherein the common I/O format of the ED comprises a plurality of character separators between the plurality of fields.

12. A system for generating a page of an electronic document (ED), comprising:
a hardware processor;
a layout engine executing on the hardware processor and configured to:
obtain a common input/output (I/O) format of the ED, wherein the common I/O format comprises a plurality of objects, a plurality of properties, and a plurality of fields corresponding to the plurality of objects;
populate, during a first layout and based on the plurality of properties, the plurality of fields in the common I/O format of the ED with a plurality of coordinates; and
generate, from the common I/O format of the ED, the page by placing the plurality of objects on the page according to the plurality of coordinates.

13. The system of claim 12, further comprising:
a format generator operatively connected to the layout engine and configured to:
receive the ED comprising the plurality of objects and the plurality of properties; and
generate the common I/O format of the ED by creating the plurality of fields corresponding to the plurality of objects.

14. The system of claim 12, wherein the common I/O format of the ED further comprises:
a fill-in box for a page number and a field corresponding to the fill-in box,
wherein the layout engine is further configured to populate the fill-in box with the page number and populate the field corresponding to the fill-in box with coordinates of the page number.

15. The system of claim 12, wherein the common I/O format of the ED further comprises:
a plurality of tags specifying the plurality of properties, wherein the plurality of properties comprises at least one selected from of a group consisting of a font size, a font type, spacing, and a margin.

16. The system of claim 12, wherein the layout engine is further configured to:
identify a conflict resulting from the first layout; and
update, during a second layout by the layout engine, at least one of the plurality of coordinates.

17. The system of claim 12, wherein each field of the plurality of fields is adjacent to a corresponding object of the plurality of objects in the common I/O format of the ED.

18. The system of claim 12, wherein the common I/O format of the ED comprises a table having the plurality of fields.

19. A computer readable medium comprising computer readable program code embodied therein for generating a page of an electronic document (ED), the method comprising:
obtaining a common input/output (I/O) format of the ED, wherein the common I/O format comprises a plurality of properties, a plurality of objects, and a plurality of fields corresponding to the plurality of objects;
sending the common I/O format of the ED to a layout engine, wherein the layout engine is configured to populate, during a first layout and based on the plurality of properties, the plurality of fields in the common I/O format of the ED with a plurality of coordinates; and
generating, from the common I/O format of the ED, the page by placing the plurality of objects on the page according to the plurality of coordinates.

20. The computer readable medium of claim 19, wherein obtaining the common I/O format comprises :
receiving the ED comprising the plurality of objects and the plurality of properties; and
generating the common I/O format of the ED by creating the plurality of fields corresponding to the plurality of objects.

21. The computer readable medium of claim 19, wherein the common I/O format of the ED further comprises:
a fill-in box for a page number and a field corresponding to the fill-in box,
wherein the layout engine populates the fill-in box with the page number, and
wherein the layout engine populates the field corresponding to the fill-in box with coordinates of the page number.

22. The computer readable medium of claim 19, wherein the layout engine is further configured to:
update, during a second layout by the layout engine, at least one of the plurality of coordinates after a conflict resulting from the first layout is identified.

23. The computer readable medium of claim 19, wherein each field of the plurality of fields is adjacent to a corresponding object of the plurality of objects in the common I/O format of the ED.
